(19) United States
(12) Patent Application Publication
(10) Pub. No.: US 2007/0083414 A1
(43) Pub. Date: Apr. 12, 2007

(54) Scalable, low-latency network architecture for multiplexed baggage scanning

(75) Inventor: Robert M. Krohn, Owego, NY (US)

Correspondence Address: BURNS & LEVINSON, LLP;(FORMERLY PERKINS SMITH & COHEN LLP), 125 SUMMER STREET, BOSTON, MA, 02110, US

(73) Assignee: Lockheed Martin Corporation, Bethesda, MD (US)

(21) Appl. No.: 11/441,520

(22) Filed: May 26, 2006

Related U.S. Application Data
(60) Provisional application No. 60/684,891, filed on May 26, 2005.

(51) Int. Cl. G06F 17/50; G05B 19/418

(52) U.S. Cl. 705/8; 705/7

(57) ABSTRACT

Network architecture for image scanning, providing a scalable, low latency arrangement for multiplexed scanning. A system and method for inspecting baggage having a plurality of scanners for providing images of the baggage and a plurality of workstations for receiving the images. There is workflow software for managing the workflow messages exchanged between the scanners and the workflow management system, and exchanged between the workstations and the workflow management system. The workflow software enables the images to be communicated directly from the scanners to the workstations over an image communications path and the workflow software enables the workflow messages to be communicated to the workflow management system over a workflow management communications channel and there is a results analyzer executing in the workstations and analyzing the images to provide inspection results of the baggage.

### CROSS REFERENCE TO RELATED APPLICATIONS

The present application claims priority to U.S. Provisional Application No. 60/684,891 filed May 26, 2005 entitled SCALABLE, LOW-LATENCY NETWORK ARCHITECTURE FOR MULTIPLEXED BAGGAGE SCANNING, and the entire content thereof is hereby incorporated by reference.

This invention was made with government support under 03-G-018 awarded by the Federal aviation administration. The government has certain rights in this invention.

### BACKGROUND OF THE INVENTION

The TSA and other similar agencies throughout the world have the task of identifying dangerous devices and/or contraband within items such as, for example, passenger baggage. The identification should ideally occur within a timeframe that will not impede passenger travel time. Most X-ray scanning systems in use today include an X-ray source, a detector array, and a conveyor belt for transporting items such as, for example, baggage, between the source and detector array as the items pass through the scanner. These scanning systems are for detecting explosive systems and are referred to as Explosive Detection Systems (EDS). These devices are installed in virtually every United States airport, and can include rotating X-ray source generates X-ray beams that pass through and are partially attenuated by the baggage, as the baggage is moved into and positioned within the beams, before being received by the detector array. These devices, also known as scanners, are based upon X-ray CT systems and produce 3-D images of X-ray attenuation of the interior of luggage, packages and the like that are reviewed for evidence of hidden explosives.

The massive amounts of data acquired by the detector array during each measuring interval can create various problems. Further, since a single orientation X-ray image of an object within an item of baggage does not readily permit spatial or other differentiation between the targeted object and the objects lying in the same x-ray path, many devices use multiple images thereby increasing the amount of information collected. Collectively, these images are combined to create a 3-D representation of the object being scanned. Accordingly, a great deal of effort has been made to design a feasible X-ray baggage scanner for providing greater detection of suspect objects and materials.

When employing CT imaging for baggage scanning, physical attributes of the object, such as density, shape and effective-Z, can be identified. These attributes can thereafter be used to automatically identify the object through computerized comparisons, and/or to display a reconstructed image on a display terminal for analysis by a professional security specialist.

However, one important design criteria for a baggage scanner is the speed with which the scanner can scan an item of baggage. To be of practical utility in any major airport, a baggage scanner should be capable of scanning a large number of bags at a very fast rate, and this creates enormous amounts of data to be transmitted, handled and analyzed. Other implementations of multiplexed systems have placed a workflow component in between the image generating source and the receiving device. While this method works, it has many flaws and limitations. These include lack of scalability to an any-to-any topology, long latency times, single point of failure and limited growth capability. Any-to-any topology ensures that any quantity of scanners can fully access any quantity of operator terminals, without limitations imposed by the network or the workflow management system.

Interconnecting multiple user terminals to multiple CT-based explosive detection systems poses challenges due to the real-time nature of the operational process and the very large image data sizes that are involved. By separating the workflow component from the image data path and enabling a central or distributed workflow manager to orchestrate all inter-device communications, the flaws and limitations of former implementations can be avoided.

### SUMMARY OF THE PRESENT INVENTION

The problems set forth above as well as further and other problems are solved by the present invention. The solutions and advantages of the present invention are achieved by the illustrative embodiment of the present invention described hereinbelow.

The system and method of the present invention provide a scalable, low-latency network architecture arrangement for multiplexed item scanning, where items such as baggage are scanned. For example, the system and method may be used in places where security is an issue, such as airports, where items are scanned prior to being loaded onto airplanes. Such systems and methods require both speed and reliability so that the airport processes, such as movement of passengers through security areas, are not significantly delayed by the security inspections provided by the security apparatus and systems. Further, the system and method are appropriate for use to check items for security when they are not in the possession of passengers.

The system and method of the present invention separate the workflow management function from the data transfer function in a multiplexed environment to overcome the limitations of the prior art. This concept totally separates controlling functions and activities from the data associated with performing the actual functions of the system, e.g., sending baggage images and receiving analysis results. A workflow management function is utilized to manage the connections between all scanners and all operator terminals. This construct allows workflow management to be implemented either centrally or distributed across workstations with no overhead added to the high-bandwidth data paths that exist between the scanners and the user terminals. The present invention can also be used for data security and systems integration.

For a better understanding of the present invention, together with other and further objects thereof, reference is made to the accompanying drawings and detailed description. The scope of the present invention is pointed out in the appended claims.

### BRIEF DESCRIPTION OF THE SEVERAL VIEWS OF THE DRAWING

FIG. 1 (PRIOR ART) is a schematic block diagram of the system of the prior art that includes a server;

FIG. 2 is a schematic block diagram of an illustrative embodiment of the system of the present invention which provides for centralized work flow management through a workflow management computer;

FIG. 3 is a schematic block diagram of an illustrative embodiment of the present invention which provides for workflow management that is distributed across the workstations;

FIG. 4 is a schematic block diagram of the present invention that illustrates the separate data and control communication paths;

FIG. 5 is a schematic block diagram of the work flow manager architecture; and

FIG. 6 is a messaging sequence diagram, illustrating how workflow management is accomplished between the scanner, the workflow manager, and the workstations within this network construction.

### DETAILED DESCRIPTION OF PREFERRED EMBODIMENTS

The present invention is now described more fully hereinafter with reference to the accompanying drawings, in which the illustrative embodiment of the present invention is shown.

An illustrative embodiment of the present invention provides for interconnecting any number of user terminals, also referred to herein as workstations, to any number of CT-based explosive detection systems to provide for item inspection. The requirements for such a system pose challenges due to the real-time nature of the operational process and the very large image data sizes that are involved. The methods employed in the present invention address these challenges and yield a maximally scalable system that minimizes system performance impacts such as latency, service priority, and system reliability.

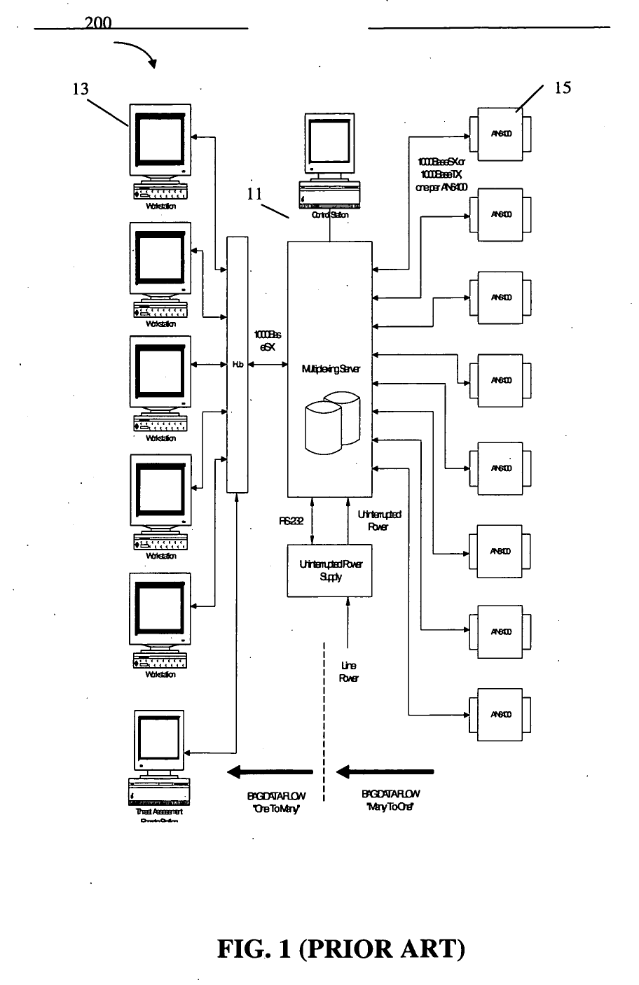

FIG. 1 (PRIOR ART) illustrates system 200 including multiplex server 11 as the workflow component that intercepts data and control streams exchanged between scanners 15 and workstations 13. Multiplex server 11 is likely to create a bottleneck between the scanners 15 and workstations 13. Another type of bottleneck could occur if the data/messaging protocol is forced through multiplex server 11.

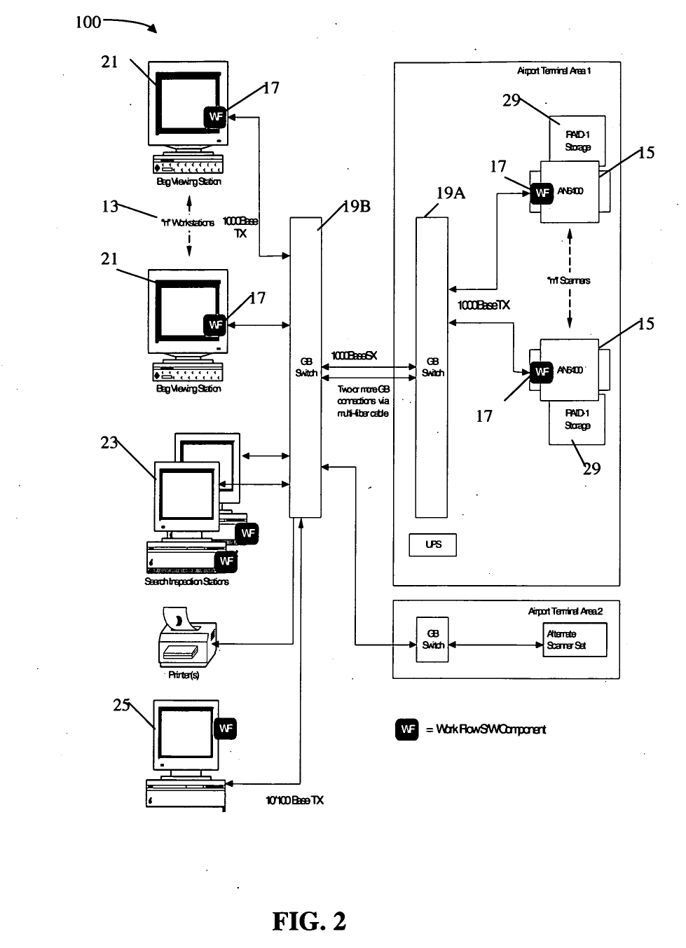

Referring now to FIG. 2, system 100 can include, but is not limited to, scanners 15, storage device 29, workstation high-speed switch 19B, scanner high-speed switch 19A, workflow software 17, workstations 13, and workflow management computer 25. System 100 can optionally include specialized workstations such as bag viewing station 21 and search inspection workstation 23. System 100 illustrates a centralized workflow management embodiment of the present invention. In the illustrative embodiment, scanner 15 can be a CT-based scanner such as, for example, an AN6400 available from Lockheed Martin Corporation. In this description, a workstation 13 is also known as an “operator terminal” or a “user terminal”, this terminology is used interchangeably. Standard networking equipment, in the form of high-speed switches, is illustrated at a high-level. In the illustrative embodiment, the high-speed switches can communicate using a fiber optic gigabit ethernet standard known as 1000BASE-SX which operates over multi-mode fiber using a 850 nanometre near infrared light wavelength. The standard allows for a maximum distance between endpoints of 220 meters over 62.5/125 μm fibre although in practice, with good quality fibre and terminations, the standard can operate correctly over significantly longer distances. 50/125 μm fibres can reliably extend the signal to 400 meters or more. The 1000BASE-SX can be used for intra-building links in large office buildings, colocation facilities, and carrier neutral internet exchanges. Further, in the illustrative embodiment, the nodes in the network (scanners 15, workstations 13, and workflow management computer 25) can communicate using one implementation of Gigabit Ethernet known as 1000BASE-TXm which is appropriate for a computer network that transmits data at a nominal speed of 1 gigabit per second. As shown in FIG. 2, multiplexing relies on a robust network between workstations 13 and scanners 15.

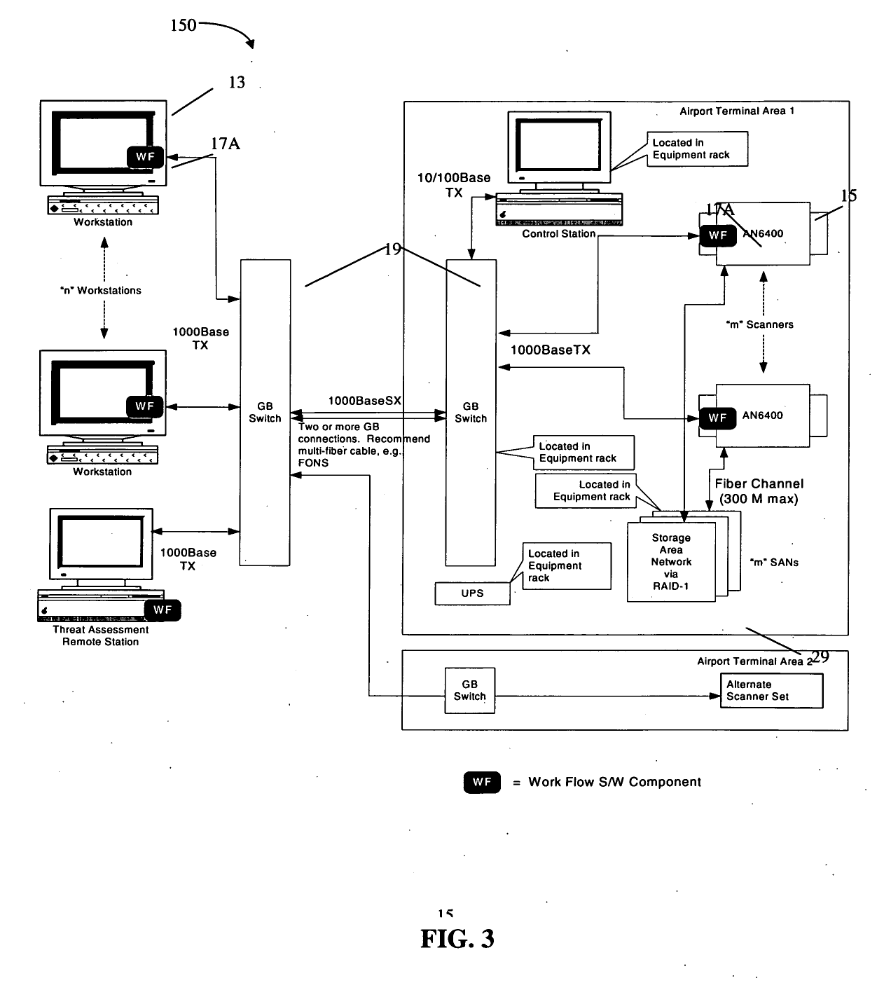

Referring now to FIG. 3, system 150 includes workstations 13 having distributed workflow software 17A which provides for distributed workflow management. Thus, there is no workflow management computer 25 in system 150. Distributed workflow software 17A in each node in the topology contains a workflow component that enables collaborative workflow functionality.

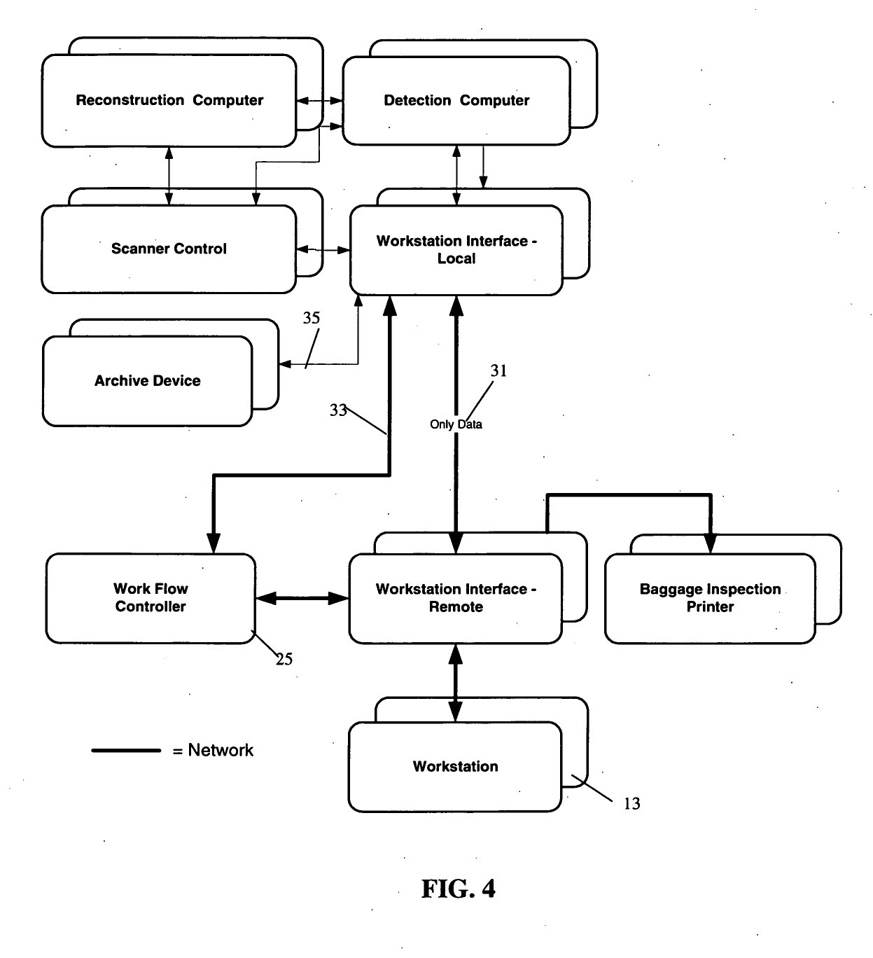

Referring now to FIG. 4, system 100 can include, but is not limited to, the shown functions. In particular, workflow management communication path (33) and image communication path (31) are shown will illustrate that workflow messages and images are transmitted along different communication paths in the network.

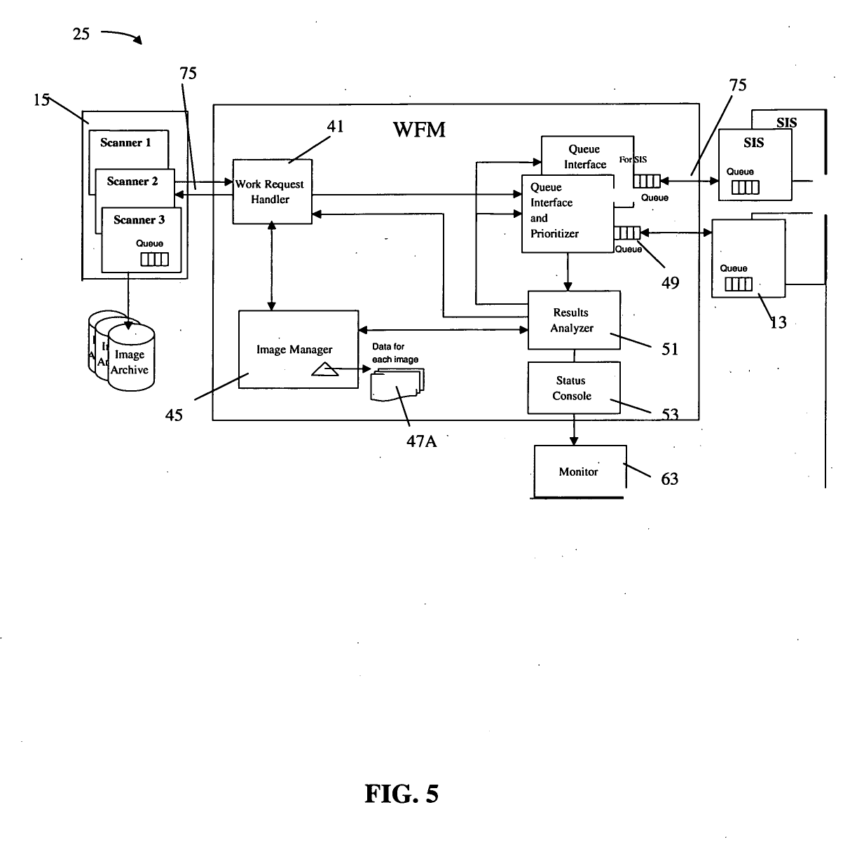

Referring now to FIG. 5 workflow management computer 25 can include architectural elements such as, for example, work request handler 41, queue 49, image manager 45, and results analyzer 51. Work request handler 41 receives requests from other components of system 100 for services. The requests are queued, prioritized and presented to workstations 13 in a way that optimizes their utility, maximizing timeliness, system throughput, and availability. Image pointers 47A are, for example, virtual pointers to images 47 (FIG. 2).

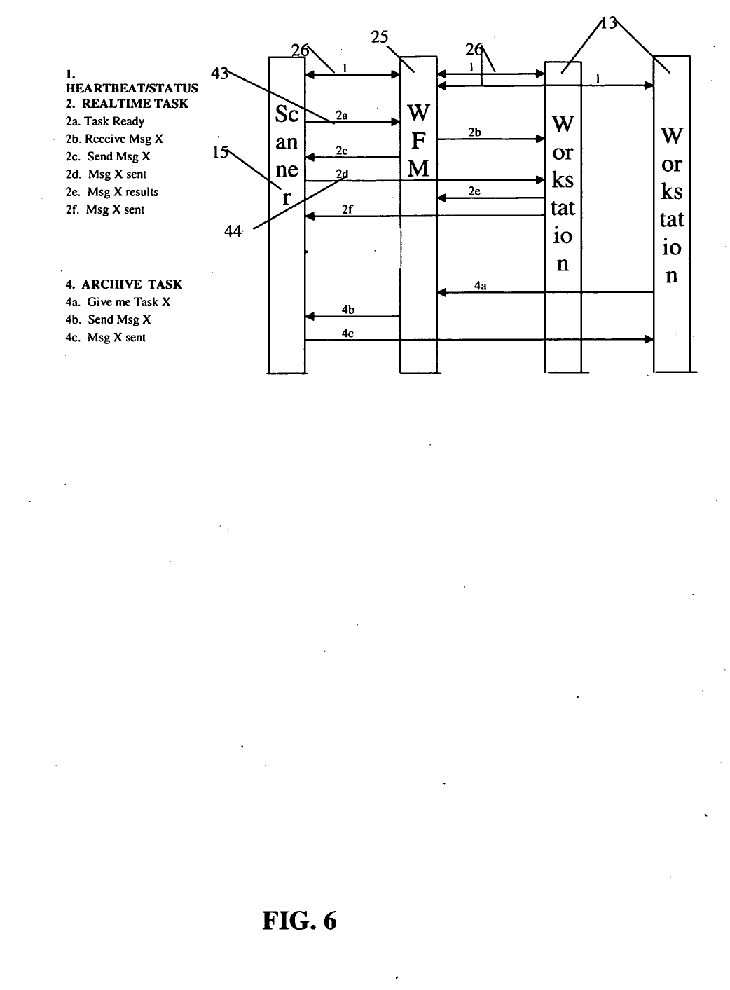

Referring now to FIG. 6, workflow management is accomplished among scanner 15, workflow management computer 25, and workstation 13 by a sequence of messages. In FIG. 6, message sequencing proceeds from top to bottom and the messages are numbered sequentially. In particular, FIG. 6 illustrates how very large image messages, denoted as Msg X sent (2d), are able to be transmitted directly from scanner 15 to workstation 13 without traveling into or through the workflow management computer 25. FIG. 6 illustrates a periodic (heartbeat) communication 26 that constantly flows among the elements of the system and is initiated between all subsystems. Periodic communication 26 is performed so that workflow management computer 25 has real-time knowledge of the availability of each subsystem. Another set of messages referred to as real-time task messages, begin with scanner 15 indicating readiness to be serviced (2a). Workflow management computer 25 selects one of workstations 13 (workstation #1 in this example) and sends it message 2b which indicates that workstation #1 will be receiving an image. Note that acknowledgements are not indicated in this diagram, although they are part of the protocol. Workflow management computer 25 informs scanner 15 that workstation #1 is ready to receive (2c). Scanner 15 sends image 47 directly to workstation #1 without flowing through workflow management computer 25 (2d). The results of the workstation activity are sent in two messages (2e and 2f) to both scanner 15 and workstation management computer 25, which both use the results for bag dispositioning and workflow status monitoring. In a similar manner, archiving messages are shown to accomplish image archiving.

Although the invention has been described with respect to various embodiments, it should be realized this invention is also capable of a wide variety of further and other embodiments within the spirit and scope of the appended claims.

What is claimed is:

1. A system for inspecting an item comprising:
at least one scanner capable of providing an image of the item;
at least one workstation capable of receiving said image; and
workflow software capable of managing at least one workflow message exchanged between said scanner and said workflow management computer, and exchanged between said workstation and said workflow management computer;
wherein said workflow software enables said image to be communicated directly from said scanner to said workstation over an image communications path and said workflow software enables said workflow message to be communicated to said workflow management computer over a workflow management communications channel; and
wherein a results analyzer executing in said workstation analyzes said image to provide inspection results of the item.

2. The system as defined in claim 1 wherein there is a plurality of scanners, workstations and images, and there is a plurality of items, and the items are luggage.

3. The system as defined in claim 2 further comprising:
a scanner high speed switch electronically coupled with said scanners, said scanner high speed switch transmitting said images to said workstations; and
a workstation high speed switch electronically coupled with said workstations, said workstation high speed switch receiving said images from said scanner high speed switch and supplying said images to said workstations.

4. The system as defined in claim 3 wherein said workflow management computer is electronically coupled with said workstation high-speed switch.

5. The system as defined in claim 3 wherein said workstation high-speed switch communicates with said scanner high-speed switch using a 1000BaseSX standard.

6. The system as defined in claim 2 further comprising:
a storage capable of receiving said image for archiving.

7. A workflow management system comprising:
at least one scanner for scanning items;
a work request handler for receiving workflow messages from said scanner;
an image manager for receiving images from said scanner;
at least one queue for queuing said workflow messages received from said work request handler, said queue queuing said workflow messages received from a workstation; and
a results analyzer for dequeuing said workflow messages and retrieving the images from said image manager according to information provided in said workflow messages;
wherein said results analyzer provides image processing results to said work request handler, to said queue, and to a status console for enabling a user to inspect the items associated with said images.

8. The system as defined in claim 7 wherein said work request handler receives the images and provide said images to said image manager.

9. The system as defined in claim 7 wherein said image manager executes in a workstation and said work request handler executes in a workflow management computer.

10. A method for processing a scanned image of an item comprising the steps of:
selecting, by a workflow management computer, a workstation;
communicating to the workstation, from the workflow management computer, that the scanned image of the item is to be transmitted;
receiving, into the workflow management computer, an indication from the workstation that the workstation is ready to receive the scanned image;
communicating, from the workflow management computer, to a scanner that the workstation is ready to receive the scanned image;
communicating the scanned image from the scanner directly to the workstation;
processing the scanned image in the workstation; and
providing results of said step of processing to the scanner and to the workflow management computer.

11. The method of claim 10 further comprising the step of:
tracking, by the workflow management computer, the availability of the workstation and the scanner by enabling periodic communication among the workstation, the workflow management computer, and the scanner.

12. A workflow management system for carrying out the method according to claim 10.

13. A communications network comprising the workflow management system according to claim 10.

14. A computer data signal embodied in electromagnetic signals traveling over a computer network carrying information capable of causing a workflow system in the network to practice the method of claim 10.

15. A computer readable medium having instructions embodied therein for the practice of the method of claim 10.
